(19) United States
(12) Patent Application Publication
(10) Pub. No.: US 2004/0262255 A1
(43) Pub. Date: Dec. 30, 2004

(54) Fabrication method at micrometer-and nanometer-scales for generation and control of anisotropy of structural, electrical, optical and optoelectronic properties of thin films of conjugated materials

(76) Inventors: Mauro Murgia, Bologna (IT); Paolo Mei, Bologna (IT); Fabio Biscarini, Bologna (IT); Carlo Taliani, Bologna (IT)

Correspondence Address: Modiano & Associati, Via Meravigli 16, Milano, 20123, IT

(21) Appl. No.: 10/490,697

(22) PCT Filed: Oct. 7, 2002
(86) PCT No.: PCT/EP02/11218

(30) Foreign Application Priority Data
Oct. 8, 2001 (IT) MI2001A002075

(51) Int. Cl. H05B 33/10

(52) U.S. Cl. 216/4; 216/28

(57) ABSTRACT

A non-conventional lithographic process for modifying, improving and fabricating structural anisotropy, organization and order, and anisotropy of the mechanical, electrical, optical, optoelectronics, charge-carrying and energy-carrying properties in thin films constituted by organic materials with double conjugated bonds. The method consists in molding, performed directly on the conjugated thin film by virtue of intimate contact with the surface of a mold. The parts of the film in direct contact with the mold undergo a transformation that is local in character and whose dimensions depend on the dimensions of the structures provided on the mold. Molding can be performed both in static conditions and in dynamic conditions.

### TECHNICAL FIELD

The present invention reports a method for micrometer- and nanometer-scale fabrication suitable to generate and control the anisotropy of relevant properties, viz. structural, mechanical, electrical, optical and optoelectronic, of thin films of conjugated materials.

### BACKGROUND ART

Conjugated materials consist of organic molecules, coordination compounds, polymers, copolymers and polymeric mixtures, containing functional groups with spatially delocalized pi-electrons on the various component atoms (C, N, O, S). These materials exhibit an optical and electronic behavior similar to inorganic semiconductors (and hence, are often termed organic semiconductors). Moreover, it has been demonstrated that they can behave like metals or superconductors upon appropriate experimental conditions. The spatial distribution of pi-electrons in a molecule is generally anisotropic. This implies that the response of an aggregate of molecules in electromagnetic fields, hydrodynamic flow, mechanical forces, can be, in principle, anisotropic depending on the order parameters.

Conjugated materials are important for the development of innovative technologies such as organic (or plastic) optoelectronics, electronics and photonics. These terms designate a variety of systems, devices, circuits and integrated components (both optical and electronic) where a thin film of a conjugated material, whose thickness ranges between 10 and 1000 nanometers, plays the role of the transport layer of charge or energy in the form of radiation.

Organic optoelectronics and electronics are alternative technologies with respect to conventional semiconductor technology for a variety of consumers' applications for everyday's life, because of their low manufacturing cost, with components that are disposable and recyclable with low environmental impact. Example products are smart cards (with information coded and modifiable in microprocessors based on a conjugated film on a plastic medium); light-emitting diodes working with molecular and/or polymeric electrolummescent thin film, for producing ultraflat, high-efficiency and ultra-bright, flexible screens; environmental and health sensors with high biological compatibility and low weight; labels for identifying widely used goods (food, clothing, letters, parcels) with information that is accessible at any times, directly and noninvasively; security (credit cards, parcels, letters) and cryptography. It has been estimated that for organic integrated circuits alone, this market will amount to more than 700 million euros toward the end of 2002.

The success of this technology relies not only on the peculiar properties of the conjugated material, but also on the effectiveness, simplicity and cost of device manufacturing.

Among non-conventional fabrication methods (i.e., methods alternative to those based on photolithographic processes), contact printing and imprinting (embossing) are the most promising for the fabrication of organic integrated circuits. This is due to the simplicity of the approaches, their compatibility with planar technology, the limited number of processes involved, the lower requirements in terms of energy, environmental cleanness and chemical hazards, and finally to the potential to upscale the process to a cyclic automated form that is repeatable a large number of times over large areas. These methods, which have been protected by international patents, are meant to imprint structures on a thin film of resistive material, which is then subjected to a developing process and to various other steps (for example anisotropic etching, lift-off, thin film deposition), to result at the end in a pattern or motif of interest. The fabricated object is generally different from the imprinted material. International patents relevant to the present patent protect i) the process of pressure embossing on photosensitive; resin to produce reflective screens (Kano et al., Alps Electric Co. Ltd. (JP) Appl. No. 170715, 13 Oct. 1998); ii) the nanostructuring of surfaces by a combination of electron-beam lithography and pressure imprinting, lift-off and/or rolling processes, with the aim of increasing the transmissivity of elementary particles through a potential barrier (Cox et al., Borealis Technical Limited (London, UK), Appl. No. 045299, 20 Mar. 1998); iii) systems for obtaining lithographic configurations on a submicrometer scale by pressing molds impregnated with reagent against the surface (Biebuyck and Michel, International Business Machine Corporation (Armonk, N.Y.), Appl. No. 690956, 1 Aug. 1996); iv) the process of imparting a topographic contrast to a metallic firn, followed by processes of corrosive dissolution (etching) to fabricate metallic films (Calveley (Private Bag, MBE N180 Auckland, NZ), Appl. No. 474420, 29 Dec. 1999); v) Chou S. and Zhuang L. (Princeton University NJ, Appl. No. US23717, 8 Oct. 1999).

The impact of nanotechnologies on the sustainable growth of advanced economies is demonstrated by government funding in the USA, Japan and European Union. The European Commission has allocated 1300 million euros of funding in the thematic priority in Nanotechnologies in the Sixt Framework Programme starting from 2003.

### DISCLOSURE OF THE INVENTION

The aim of the present invention is to provide a process that allows one to modify, enhance, manipulate and fabricate the structural organization, order and anisotropy of conjugated molecules and/or macromolecules in a thin film.

An object of the present invention is to provide a process that is suitable to produce a thin film constituted by isotropic regions and anisotropic regions with higher or different molecular order, and accordingly a spatial modulation, also with a preset periodicity, of the tensor properties that depend on molecular order, such as for example polarizability, hyperpolarizability, dielectric permittivity, linear and nonlinear refractive indices, charge mobility, electrical conductivity, thermal conductivity, magnetization and magnetic susceptibility, elasticity, plasticity and stress.

Another object of the present invention is to provide a process that can be performed on a large scale and is repeatable for a large number of cycles and can be engineered in an existing and commercial technology.

Another object of the present invention is to provide a process that allows one to modify, enhance, manipulate and fabricate the structural organization, order and anisotropy of the conjugated molecules in a thin film at length scales ranging from micrometers to nanometers.

Another object of the present invention is to provide a process for fabricating domains with controlled shape, spatial distribution, and anisotropy in linear and nonlinear optical and electrical responses.

Another object of the present invention is to provide a process for producing thin films of conjugated materials with specific properties in terms of anisotropy of structural, electrical, optical and optoelectronic properties that is effective, simple and has low production costs.

This aim and these and other objects, that will become better apparent from the description that follows, are achieved by a process and a film as defined in the appended claims.

The invention provides a process for modifying the tensor properties of a thin film constituted by conjugated, materials, which includes the step of placing said film in contact with a mold and applying a molding pressure to said mold.

The conjugated material can be chosen from the group constituted by conjugated molecules and polymers with a rigid rod-like conjugated unit, crystalline liquid polymers and molecules based, on rod-like or biaxial structures.

The conjugated molecules and the polymers with rod-like conjugated unit are chosen for example from the group constituted by oligothienyls, preferably quater-, quinque-, sexi-, septi-, octothienyls, derivatives thereof with substitutions in the α and/or ω positions or in the β or β′ positions, or in any of the positions α, ω, β or β′, and corresponding regioregular and non-regioregular polymers thereof; oligophenyls, preferably quater-, quinque-, sexi-, septi-, octophenylenes, derivatives thereof with substitutions in the ortho and/or meta positions, corresponding regioregular and non-regioregular polymers thereof; naphthalene, anthracene, phenanthrene, tetracene, pentacene, and acene derivatives; bis-dithieno-thiophene; bis-dithieno-fulvalene; fluorenes, bis-dithieno-fluorenes and derivatives thereof; oligophenylenevinylene, preferably quater-, quinque-, sexi-, septi-, octophenylenevinylene, derivatives thereof with substitutions in the ortho, meta and/or allyl positions; corresponding regioregular and non-regioregular is polymers thereof; and bis-distyryl-stilbene.

The material can also be chosen from the group constituted by conjugated molecules and polymers having a disk-like conjugated unit, for example perylene and derivatives thereof, preferably 3,4,9,10-perylene-tetracarboxylic dianhydride (PTCDA), naphthalenetetracarboxylic dianhydride (NTDA); terrylene, coronene, hexabenzocoronene, with or without substitutions; phthalocyanines and porphyrins preferably with metallic centers of Cu or Zn; crystalline liquid molecules based on a disk-like structure.

Furthermore, the material can be chosen from the group constituted by coordination compounds and molecules that have a strong electron anisotropy by way of the electrical dipole, such as tris-(hydroxyquinoline)Al(III), known as Alq3, and its derivatives with different metallic centers such as vanadyl, Pd, Pt, Zn, Ga, In, Tl, Sn, rare earth elements, or with different ligands, such as hydroxyquinoline substituted in positions 2 or 4 or 5 and more generally aromatic chelating agents based on oxygen and nitrogen.

The tensor properties that can be modified with the process according to the present invention are for example polarizability, dielectric permittivity, refractive index, optical absorption, energy transport, charge mobility, electrical and thermal conductivity, magnetization and magnetic susceptibility, elasticity, plasticity and stress.

The mold used in the process according to the present invention can be a single protrusion, preferably having characteristic dimensions in the micrometer to nanometer range, or can have multiple protrusions.

The mold used can be a hard mold, preferably made of chromium, steel silicon nitride or silicon oxide, or a mold made of an elastomeric material, preferably poly-(dimethylsiloxane).

The printing pressure used in the process according to the present invention can be in the range between 1 and 1000 bar.

The molding step of the process according to the present invention preferably occurs at a temperature in the range between 0 and 300° C.

During molding, the mold applies to said film normal and/or lateral static or dynamic forces.

The printing process can be performed on a large area with respect to the characteristic dimensions of the protrusions of the mold.

The mold can be applied in a configuration that is perpendicular or tilted with respect to the surface, thus producing a continuous spatial variation of the orientation produced in the thin film.

When the mold is constituted by multiple protrusions, the pressure applied to the film by each protrusion can also be controlled individually, for example by means of individually addressable piezoelectric elements.

Said pressure can be modulated locally, thus inducing a continuous or discrete variety of molecular reorientation.

In the process according to the present invention, the possibility to modulate the reorientation according to the exerted pressure can be exploited to write information on the film with the same modulation, thus achieving a storage density of information that is equal to, or greater than, the density offered by binary systems.

### BRIEF DESCRIPTION OF THE DRAWINGS

The invention is described in greater detail with reference to the accompanying figures, wherein:

FIG. 1 is a schematic view of the printing step of the process according to the present invention.

FIG. 1a is a diagram of the static molding process.

FIG. 1b is a diagram of the dynamic molding process performed with a sphere.

FIG. 2 illustrates Raman microscope images of molded lines: (a) width 5 μm and period 10 μm (b) width 200 nm and period 1 μm (c) intensity profiles across the stretching direction of the printed lines in (a). The Raman intensity is higher at the molded lines.

FIG. 3 illustrates the Raman dichroism obtained with a Raman microscope on non-molded regions (a) and molded lines (b). The dichroic ratio of the intensities is 1.6 and 2.2 for polarization parallel and perpendicular to the molded lines, respectively. Thus, molding results in an enhancement of anisotropy in excess of 35% in this case.

FIG. 4 illustrates AFM images at various magnifications, which show the quality of the process on a large area (a) and the granular morphology of the non-molded areas (b). The vertical scale (from 0 (black) to z (white) nm) is (a) z=60 nm, and (b) z=50 nm, respectively. The height of the protrusions of the mold is approximately 100 nm, and the topographical depression of the molded lines of only 20 nm indicates that the mold did not make contact with the entire surface of the film. (c) illustrates a topographical profile that is normal to the lines molded in (b), showing the depression by approximately 30% of the molded lines with respect to the crests.

FIG. 5 illustrates an experimental apparatus for performing dynamic molding (nano-rubbing). The load force is established by means of the counterweights of the rocker and can be set in a range so as to obtain suitable values of the pressure applied to the film, for example between 10⁺⁴ and 10⁺⁵ Pa. The translation of the specimen is performed by means of a micrometric xy-stage. FIG. 6 illustrates an optical image (100× magnification) under a polarizing microscope of a thin film of anisotropic conjugated molecules after nano-rubbing by means of a rolling sphere. The strong anisotropy of absorption of white light in the region affected by the process is evident.

FIG. 7 illustrates photoluminescence spectra in the channel subjected to; nano-rubbing with a large polarization ratio between the components that are parallel and perpendicular to the rubbing direction.

### WAYS OF CARRYING OUT THE INVENTION

Without intending to be constrained to a specific mechanism, it is noted that the physical principle of the process is based on the fact that thin films of anisotropic conjugated molecules have a viscous stress (shear) tensor that allows the reorientation of the molecules on the x-y plane under the action of a load that is normal along z. The molecular reorientation is localized spatially at the regions of the film in contact with the mold. Findings indicate that the onset of the local reorientation effect requires the thin film:

to be constituted by molecules or macromolecules that are anisotropic, or have anisotropic shape and polarizability, or have permanent dipoles;

to yield under the applied pressure without being completely plastic;

to have a translational viscosity that is greater than the orientational viscosity;

not to be theologically fluid, at least not in the sense of a classical isotropic liquid;

has low adhesiveness to the surface of the mold and high adhesiveness to the surface of the substrate.

Direct evidence of the process is given by the change in the structure of the film and in the orientation of the molecules, in the morphology and optical properties of the film. The modification of these properties leads to a change in the electrical charge carrying properties (example in a field-effect transistor (FET): charge mobility, on/off signal ratio, frequency dependent response rate), and in the spectroscopic properties, such as absorption and photo- and electroluminescence. Examples are the intensity of the light emitted or absorbed along various spatial directions, quantum yield, spectral quality and shape.

Molding is performed with the aid of appropriately designed molds made of metal or other material. In the dynamic case it is possible to use spherical tips (fixed or rolling ones), made to slide with a controlled loading force on the film. The temperature of the film during the process, the force applied by the mold per unit of surface in contact (i.e., the effective pressure), the dimensions of the interface in contact, and the advancement speed of the mold with respect to the film in the case of the dynamic process, are among the factors that control the extent of the transformation induced in the molecular thin film.

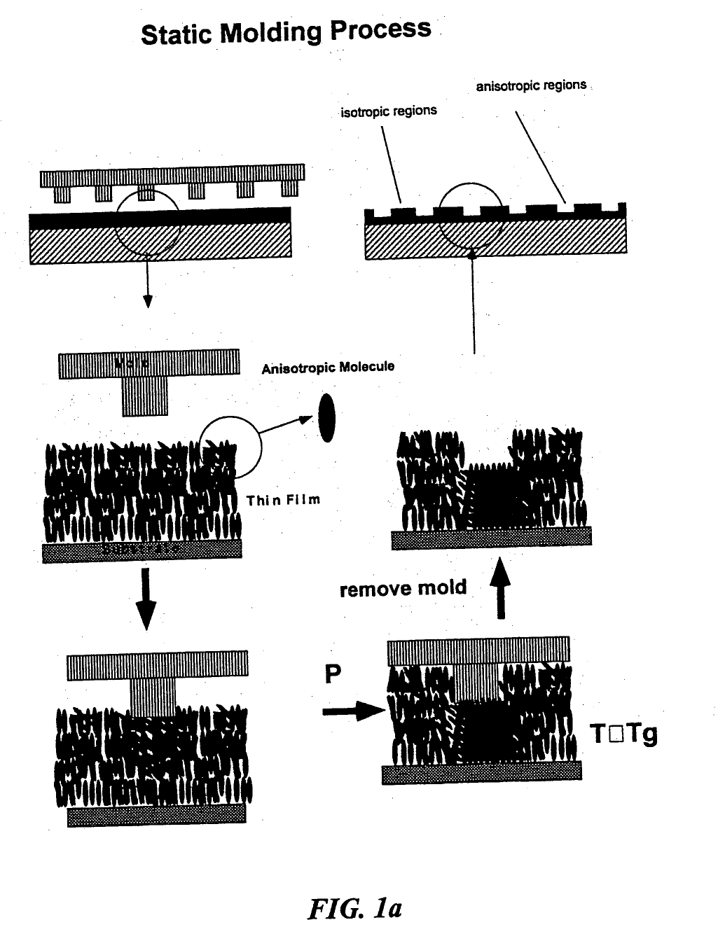

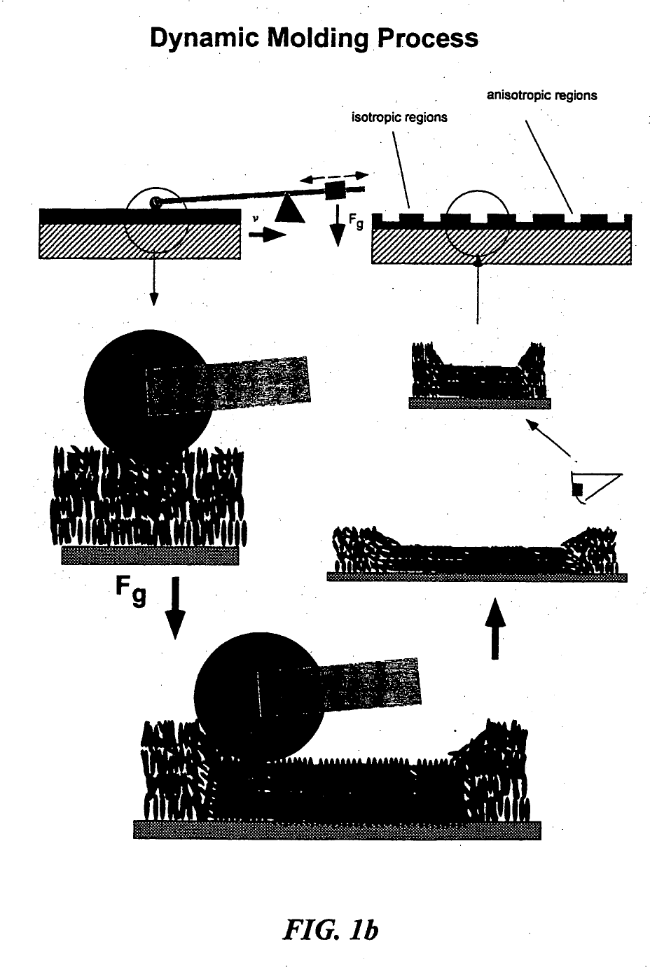

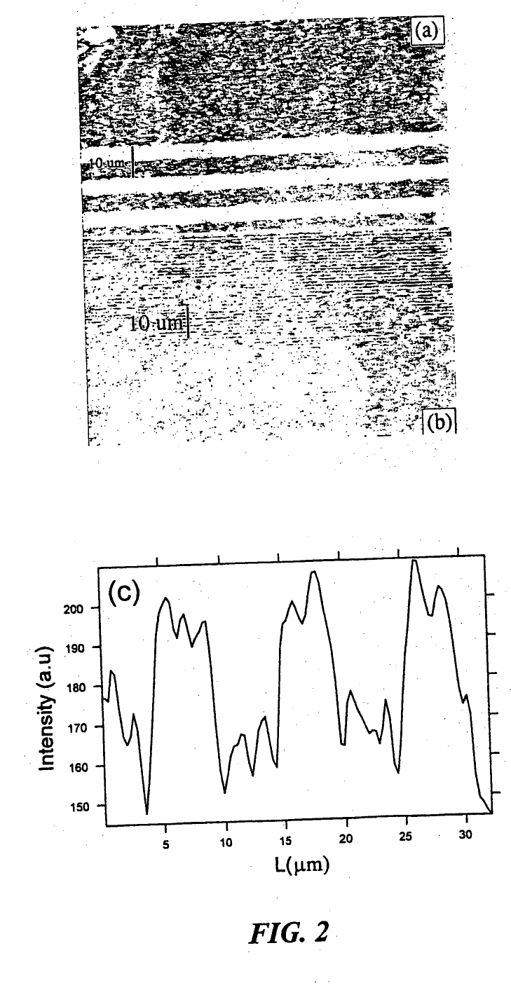

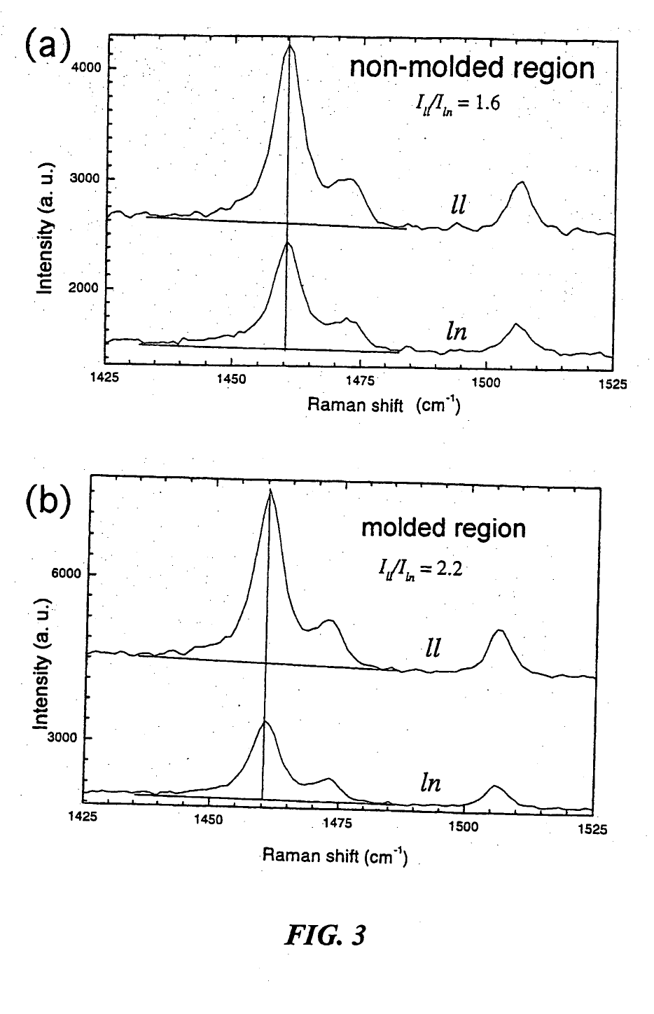

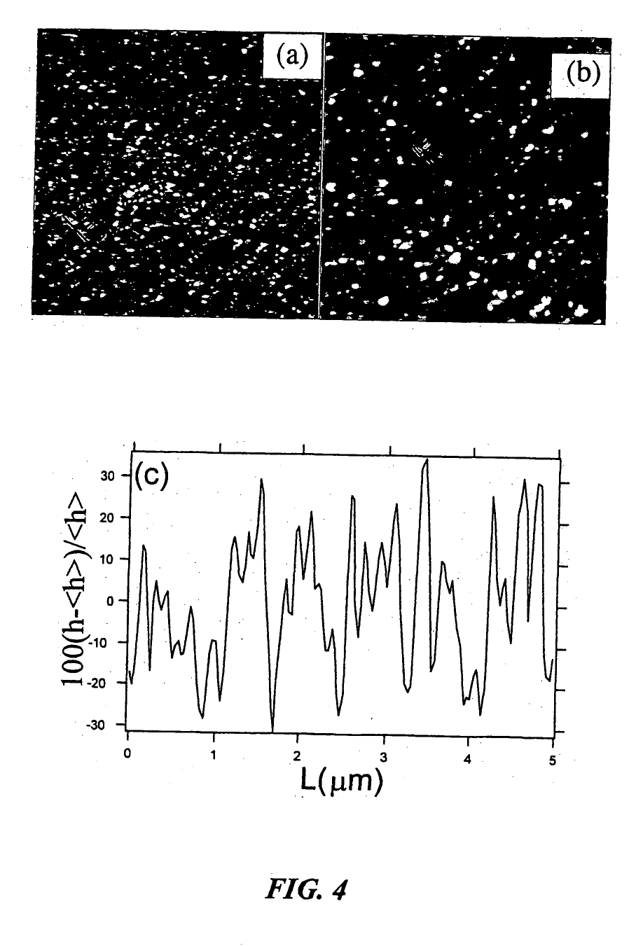

In the case of the static process (FIG. 1a), the effectiveness of the process depends on the combination of pressure P and temperature T during molding, on the duration of the molding, and on the method of engagement and contact. The surfaces are moved mutually closer and placed in contact with zero force, then the pressure is increased rapidly up to the chosen value.

The value of the nominal pressure required to perform these transformations is on the order of 0.1-10 bar/nm of thickness. The effective pressure depends on the contact area determined by the shape of the surface of the mold, on the adaptability and conformability of the conjugated material with respect to the mold, and on the relative planarity of the interfaces. The regions of the thin film in contact with the protrusions of the mold are the ones affected by the molecular reorganization process, which therefore is local in character. The shape of the mold (for example parallel lines and grooves), can produce an azimuthal orientation and therefore uniaxiality in the molded region. The result of the process described here is a thin film in which the molded regions are formed by domains of planarly oriented molecules. The molded regions are thinner than the un-molded ones because of the reduction in thickness caused by the different molecular orientation.

The temperature must be just above a threshold value (for example the glass transition temperature in a polymer), so as to allow orientational diffusion, but must not reach the melting temperature. The optimum results for thin films of conjugated molecules are obtained at temperatures that are close to, but lower than, the annealing temperature of the material at the pressure of 1 bar. This temperature is generally lower than 200° C. for conjugated molecules of interest in plastic electronics.

The duration of the molding operation is generally short with respect to the time scale of molecular reorientation and has a long range: 1-10 minutes is long enough to reach a condition of equilibrium in a 50-100 nm film. The values of P and T vary according to the materials and the thickness of the thin film.

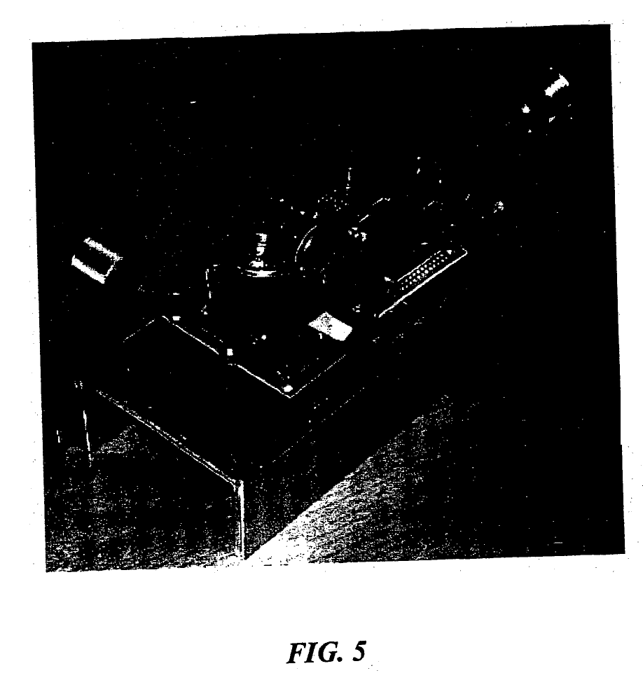

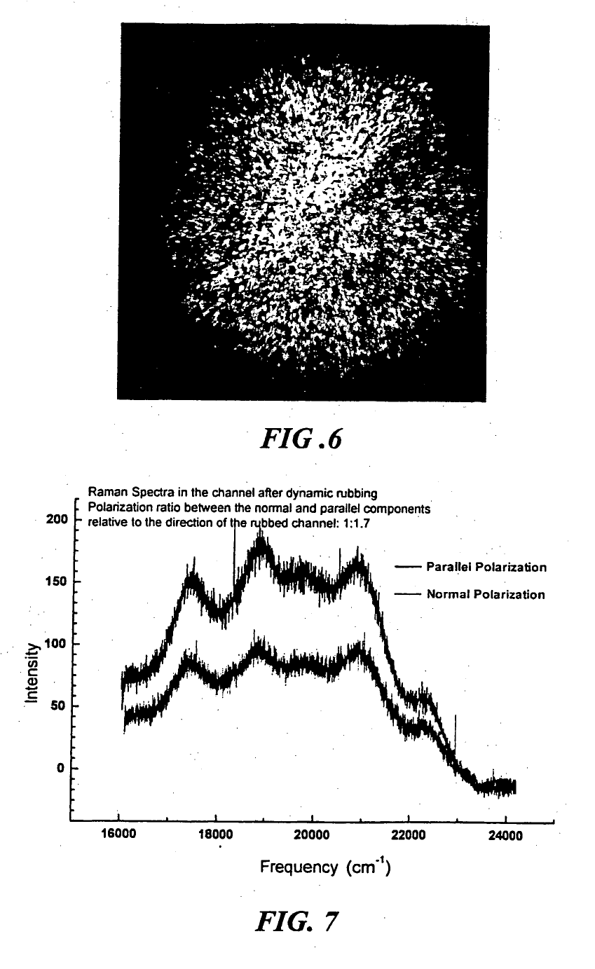

In the dynamic case (FIG. 1b), which is referenced here as micro- or nano-rubbing, molding occurs by sliding the two surfaces in contact with respect to each other. The experimental apparatus is shown in FIG. 5 in the case of a sphere having a radius of 100 gm, engaged with a preset load force on a thin film of 100 nm of sexithienyl (T6) on glass. The sliding of the ball with respect to the specimen leaves lines of uniform width, variable between 20 and 2 μm depending on the gradually decreasing load force. The polarized-light image (polarizer-analyzer configuration) under a polarized optical microscope (FIG. 6) shows an evident optical anisotropy (dichroism) in the region affected by contact with the ball, while the rest of the film maintains isotropic properties. Photoluminescence microscopy (PL) in polarized light (FIG. 7) confirms that in the molded region the molecules have a planar orientation along the advancement direction. In the part not affected by molding, the molecules are orientated isotropically on the plane. X-ray diffraction measurements from the literature [B. Servet, G.: Horowitz, S. Ries, O. Lagorese, P. Alnot, A. Yassar, F. Deloffre, P. Srivastara, R. Hajlaoui, P. Lang and F. Garnier, Chem. Mater. 6, 1809 (1994)] show that the long axis forms on average an angle of approximately 20° with respect to the normal to the surface of the substrate. Therefore, experimental evidence leads to the deduction that the molecules are reoriented with their long axis planar under the action of the force applied by the sphere.

The best results are obtained with aged films, while deterioration during the process caused by removal of material can be observed on freshly prepared films. In addition to the P and T parameters, the velocity V of the mold with respect to the specimen is also important. Typical values of V are between 1 and 10 mm/sec. Reorientation of the molecules is partly determined by the normal force and partly determined by the lateral friction force between the two surfaces, which acts on the x-y components of the viscous stress tensor.

The process described in the present invention is demonstrated with single-protrusion molds, such as for example a sphere, or a stylus for scanning probe microscopy, thus for a radius of curvature between several hundred micrometers and a few nanometers. The most general case of this invention consists of a mold with multiple protrusions or with fabricated structures of varying complexity in order to induce molecular reorientation in static or dynamic conditions. While thickness modification by static molding is known and covered by international patents (e.g. embossing, nanoimprinting), the effect of local reorientation induced by molding, which is the focus of the present patent, is absolutely original and innovative.

The molds used to induce molecular reorientation can be hard molds, for example made of chromium, steel, silicon oxide, silicon nitride. It is also possible to use molds made of elastomeric material, for example poly-(dimethylsiloxane).

The process according to the invention allows to perform local changes to the molecular orientation of a thin film by virtue of molds on a large area, controlling the molding conditions as described above.

The disclosures in Italian Patent Application No. MI2001A002075 from which this application claims priority are incorporated herein by reference.

1. A process for modifying the tensor properties of a thin film constituted by conjugated materials, comprising the step of placing said film in contact with a mold and applying to said mold a molding pressure suitable to change the orientation of the molecules constituting said materials in regions of said film in contact with the mold.

2. The process according to claim 1, wherein said conjugated material is chosen from the group constituted by conjugated molecules and polymers with a rigid rod-like conjugated unit, crystalline liquid polymers and molecules based on rod-like or biaxial structures.

3. The process according to claim 2, wherein said conjugated molecules and polymers with rod-like conjugated unit are chosen from the group constituted by oligothienyls, preferably quater-, quinque-, sexi-, septi-, octothienyls, derivatives thereof with substitutions in the α and/or ω positions or in the β or β′ positions, or in any of the positions α, ω, β or β′, and corresponding regioregular and non-regioregular polymers thereof; oligophenyls, preferably quater-, quinque-, sexi-, septi-, octophenylenes; derivatives thereof with substitutions in the ortho and/or meta positions, corresponding regioregular and non-regioregular polymers thereof; naphthalene, anthracene, phenantene, tetracene, pentacene, and acene derivatives; bis-dithieno-thiophene; bis-dithieno-fulvalene; fluorenes, bis-dithieno-fluorenes and derivatives thereof, oligophenylenevinylene, preferably quater-, quinque-, sexi-, septi-, octophenylenevinylene, derivatives thereof with substitutions in the ortho, meta and/or allyl positions; corresponding regioregular and non-regioregular polymers thereof; and bis-distyryl-stilbene.

4. The process according to claim 1, wherein said material is chosen from the group constituted by conjugated molecules and polymers having a disk-like conjugated unit.

5. The process according to claim 4, wherein said material is chosen from the group constituted by perylene and derivatives thereof, preferably 3,4,9,10-perylene-tetracarboxylic dianhydride, naphthalenetetracarboxylic dianhydride; terrylene, coronene, hexabenzocoronene, with or without substitutions; phthalocyanines and porphyrins preferably with metallic centers of Cu or Zn; crystalline liquid molecules based on a disk-like structure.

6. The process according to claim 1, wherein said material is chosen from the group constituted by coordination compounds and molecules possessing electronic anisotropy, an electric dipole.

7. The process according to claim 6, wherein said material is chosen from the group constituted by tris-hydroxyquinoline) Al(III) termed Alq3, and its derivatives with metallic centers other than Al, preferably vanadyl, Pd, Pt, Zn, Ga, In, Tl, Sn, rare earth elements, or with different bonding agents, such as hydroxyquinoline substituted in positions 2 or 4 or 5 and aromatic chelating agents based on oxygen-nitrogen.

8. The process according to claim 1, wherein said tensor properties are polarizability, dielectric constant, refractive index, optical absorption, energy transport, charge mobility, electrical and thermal conductivity, magnetization and magnetic susceptibility, elasticity, plasticity and stress.

9. The process according to claim 1, wherein said mold has a single protrusion, preferably having dimensions in the micrometer to nanometer range.

10. The process according to claim 1, wherein said mold has multiple protrusions.

11. The process according to claim 1, wherein said mold is a mold harder than said film, said mold being preferably made of chromium, steel, or silicon oxide.

12. The process according to claim 1, wherein said mold is a mold made of elastomeric material, preferably polydimethylsiloxane.

13. The process according to claim 1, wherein said pressure is comprised in the range between 1 and 1000 bar.

14. The process according to claim 1, wherein said step occurs at a temperature in the range between 0 and 300° C.

15. The process according to claim 1, wherein said mold applies to said film static or dynamic normal and/or lateral forces.

16. The process according to claim 9 or 10, wherein the molding process is performed an area larger than the dimensions of the protrusion of the mold.

17. The process according to claim 1, wherein said mold is applied in an inclined configuration with respect to the surface, thus producing a continuous spatial variation of the molecule orientation.

18. The process according to claim 10, wherein the mold is constituted by multiple protrusions whose pressure applied to the film can be controlled individually.

19. The process according to claims 1, 9, 10 and 18, wherein said pressure is modulated, thus inducing a continuous or discrete variety of molecular reorientation locally.

20. The process according to claim 19, according to which said reorientation effect can be modulated, to be used to write locally information, with a storage density that is equal to, or greater than, the density obtainable with binary writing systems.
